(19) United States
(12) Patent Application Publication
(10) Pub. No.: US 2010/0254592 A1
(43) Pub. Date: Oct. 7, 2010

(54) CALCULATING Z-DEPTHS AND EXTRACTING OBJECTS IN IMAGES

(76) Inventor: Koun-Ping Cheng, San Diego, CA (US)

Correspondence Address: LAW OFFICES OF CLEMENT CHENG, 17220 NEWHOPE STREET #127, FOUNTAIN VALLEY, CA, 92708, US

(21) Appl. No.: 12/384,124

(22) Filed: Apr. 1, 2009

(51) Int. Cl. G06K 9/00; G06K 9/48

(52) U.S. Cl. 382/154; 348/47; 382/199; 348/E13.074

(57) ABSTRACT

The dual cameras produce two simultaneous images IM1 and IM2 for a picture. To solve for Z depths, first define a set of grids {S1, S2 . . . Sk|k any integer}. The images of the grids will be used to construct a set of 3D surfaces {SF1, SF2 . . . SFk|k any integer}. Then a Z-depth function evaluator EV will be constructed by using those 3D surfaces {SF1, SF2 . . . SFk|k any integer}. Finally, for any point P on the first image IM1, EV can be used to calculate the Z-depth of P. Then reconstruct all the 3D coordinates of the objects, separate and extract all the objects in the image.

### BACKGROUND

Object extraction is a fundamental problem in computer vision and image processing. There are many applications for object extraction such as object recognition, automatic target recognition, scene analysis and monitor tracking of objects. It is important to have a dependable automated technique for object extraction. Many works have been done in this area and many technologies have been developed.

The developed technologies mostly deal with the data of the color images. U.S. Pat. No. 5,923,776 issued Jul. 13, 1999 to Kamgar-Parsi entitled Object Extraction In Images provides for as stated in the abstract, “a method and apparatus for extracting an object from an image, in which one locates a pixel within the image (the “central” pixel), and then sequentially compares the brightness of neighboring pixels, proceeding outward from the central pixel. In so doing, one determines the largest drop-offs in brightness between neighboring pixels, and uses these to determine a brightness threshold for extracting pixels belonging to the object. In a preferred embodiment, one determines the threshold by comparing the largest drop-offs, identifies overlapping regions of brightness level common to all the drop-offs, and sets the threshold at the midpoint of the common overlapping region.” The disclosure of U.S. Pat. No. 5,923,776 is incorporated herein by reference.

Chen, U.S. Pat. No. 7,324,693, entitled Method Of Human Figure Contour Outlining In Images issued Jan. 28, 2008 provides as stated in the abstract, “a digital image processing method for automatically outlining a contour of a figure in a digital image, including: testing parameters of a region within the digital image according to a plurality of cascaded tests; determining whether the region contains characteristic features of the figure within the digital image; computing location parameters of the characteristic features in the region for the figure within the digital image; determining boundary parameters for the figure corresponding to the location parameters of the characteristic features in the region; computing an information map of the digital image; computing a set of indicative pixels for the contour of the figure; and automatically outlining the contour of the figure using the set of indicative pixels, the information map, and a contour outlining tool.” The disclosure of U.S. Pat. No. 7,324,693 is incorporated herein by reference.

United States patent publication 20090028389 to Ikumi published Jan. 29, 2009 entitled image recognition method provides for as stated in the abstract, “according to an aspect of an embodiment, a method for detecting a subject in an image, comprising the steps of: dividing said image into a plurality of regions; calculating a similarity between a feature of one of said regions and the feature of another of said regions; determining a distribution of said similarities corresponding to said regions; and detecting the subject in the image by determining correlation of said distribution with a shape of said subject.” The disclosure of United States patent publication 20090028389 is incorporated herein by reference.

U.S. Pat. No. 7,418,150 to Myoga entitled Image Processing Apparatus, And Program For Processing Image issued Aug. 26, 2008 provides for, as stated in the abstract, “an image processing apparatus is configured to include: illumination controlling section for controlling emission of light with a setting amount of light; region extracting section for independently extracting the image data of an object region indicating the object, and image data of a background region indicating background other than the object from reference image data out of two pieces of image data, respectively obtained at each change in an amount of the light from the illumination unit; filter processing section for applying a filtering process with the blurring effect to at least one piece of the image data of the object region and the background region, both extracted by the region extracting section; and combining section for generating combined image data of the reference image data with the image data subject to the filtering processing out of the image data of the object region and the background region.” The disclosure of United States patent 7,418,150 is incorporated herein by reference.

The cited references show that, the color map of a photo image is often just too complicated for easy analysis. All the current developed technologies are not able to handle the difficult cases. In order to handle the complicated color images, another approach is to use the artificial intelligence (Al) to resolve the problem. Hsu in, U.S. Pat. No. 6,804,394, entitled System For Capturing And Using Expert's Knowledge For Image Processing issued Oct. 12, 2004 provides for as stated in the abstract, “an apparatus and a method for object detection in an image. The apparatus for this invention includes a preprocessor, a detector, a segmentor, a classifier, a classifier systems integrator, a system output and a post processor. The method for object detection allows the user to identify an object by using three approaches: (1) a segmentation detector, (2) a pixel-based detector, and (3) a grid-cell and mesotexture based detector. All three of the aforementioned approaches allows the user to use a pseudo-English programming language in the processing system for object detection. This invention allows the user to use an expert's knowledge and convert it to object based content retrieval algorithms. The user can preserve the segmented scenes of the original data and perform a raster-to-vector conversion which preserves the size and shape of the original objects. Further, the object based image data can be converted into geographic information system (GIS) layers which can be analyzed using standard GIS software such as ARC/Info or ARC/View.” The disclosure of U.S. Pat. No. 6,804,394 is incorporated herein by reference.

Hsu, in U.S. Pat. No. 6,724,931, entitled Compilable plain Fnglish-like language for extracting objects from an image using a primitive image map further provides additional AI. However, due to the nascent nature of AI technology, this method is neither completed nor fully automatic.

One more approach is to find the z-depths of the points on an image. The Z-depth of a point P is defined as the distance from P to the camera. Once the Z-depths are all known, we can separate/extract the objects according to their z-depths. There are many methods developed to find the Z-depths. One method uses special light source to shine on objects and then use certain light sensors to find the distance of the objects. US patent application publication 20040057613, entitled Pseudo three dimensional image generating apparatus published Mar. 25, 2004 provides in the abstract, “The pseudo depth information of a subject is generated from multiple images of the subject captured with and without illumination or under various illumination intensities. A pseudo 3D image generating apparatus generates a pseudo 3D image. It includes an image storing unit that stores the images, and a depth computing unit that computes pseudo depth values of the subject based on operations between the pixel values of corresponding pixels in the images. A compact and handy 3D image generating apparatus is provided.” The disclosure of United States patent publication 20040057613 is incorporated herein by reference.

Another method uses several images to construct Pseudo z-depths and then generate Pseudo 3D objects. Takayanagi in U.S. Pat. No. 6,396,570, entitled Distance Measurement Apparatus And Distance Measuring Method issued May 28, 2002, proposes in the abstract, “A distance measurement apparatus irradiates an object with a light from a light source whose luminance can be modulated or from a pulse light source, and receives the reflected and returned light to obtain a distance to the object. A photoelectric converter receives the reflected light and photoelectrically converts the received light. A first charge accumulator accumulates an electric charge transferred via a first gate driven by a first transfer pulse synchronized with an emitting timing of the light from the light source among electric charges generated by the photoelectric converter. A second charge accumulator accumulates an electric charge transferred via a second gate driven by a second transfer pulse complementary to the first transfer pulse among the electric charges generated by the photoelectric converter. A normalization circuit reads a first signal based on the accumulated electric charge of the first charge accumulator, and a second signal based on the accumulated electric charge of the second charge accumulator, and normalizes the smaller signal of the first and second signals with an added signal of the first and second signals.” The disclosure of U.S. Pat. No. 6,396,570 is incorporated herein by reference.

This invented method has great potential in robot vision. For background machine vision, the reader is invited to, E, R, Davies, Machine Vision: Theory, Algorithms, Practicalities, Kaufmann Publishers, 2004. Based on the historical development of machine vision, what is needed is an easier method of processing images into three-dimensional format.

### SUMMARY OF THE INVENTION

The method of extracting objects by computing all the z-depths seems to be more promising and avoids dealing with the complexity of the color map. Hence, this invented device will also take this approach, that is to first calculate all the z-depths and then use the z-depths to extract all objects from the image.

All the z-depths are initially absent from a photo or video image. For every point P on a photo, the present invention will try to reconstruct the missing z-depths. The z-depth of P is defined as the distance from P to the camera. To be able to obtain the z-depth of a point, mathematically we need to have at least two images of the same object from two different angles. Hence, the present invention device is equipped with a piece of hardware which contains two cameras, video recorders or video cameras. The dual cameras produce two simultaneous images IM1 and IM2 whenever a picture is taken.

The two pictures taken by the dual cameras image IM2 will shift a little to the right or left of image IM1. This depends on the second camera being located to the left or right of the main camera (see FIGS. 1, 3). Now for any point P on Image IM1, there is preferably a corresponding point Q on Image IM2 such that (P, Q) are the images of a same point in space. Due to the shifting of IM2 from IM1, (P, Q) will always be separated with a distance D. The value of D will depend on the distance Z from the camera to the point P (the z-depth of P).

Now this present invention method will do the reverse. i.e. given
(1) a point P on Image IM1 and
(2) a separating distance D between (P, Q),

we will then calculate the Z-depth of P.

In general, “finding the z-depth of a point P” is a very difficult problem. The calculation involves many parameters such as camera location, camera focal length, camera angle and camera lance curvature. There is no closed form solution for this problem and the math equations involved here are too complicated. In addition, the calculated results are not very satisfactory either.

To solve this problem the invented device will take a different approach. A set of grids {S1, S2 . . . Sk|k any integer} (see FIG. 7) will be constructed. The images of the grids will be used to construct a set of 3D surfaces {SF1, SF2 . . . SFk|k any integer} (see FIG. 8). Then a Z-depth function evaluator EV will be constructed by using those 3D surfaces {SF1, SF2 . . . SFk|k any integer}. Finally, for any point P on the first image IM1, EV can be used to calculate the Z-depth of P.

Once all the z-depths of the objects are calculated, we can then reconstruct all the 3D coordinates of the objects. Once the 3D coordinates are constructed, we can separate and extract all the objects in the image, and since every object occupies a different place in space the invented device can separate and extract them easily.

For background of how to construct a 3D surface over a set of points, the reader is invited to review David F. Rogers, An introduction to NURBS: with historical perspective, San Francisco Morgan Kaufmann Publishers, 2001.

### BRIEF DESCRIPTION OF THE DRAWINGS

FIG. 1 shows the structure of the dual cameras.

FIG. 2 shows using the dual cameras to take simultaneous pictures.

FIG. 3 contains two images taken from the dual cameras.

FIG. 4 shows the relation between a grid and the main camera.

FIG. 5 contains the images of a grid taken from the dual cameras.

FIG. 6 shows how to use the vertices of a grid and the separating distances to construct a set of 3D points.

FIG. 7 shows how to construct a set of grids {S1, S2, S3}.

FIG. 8 shows how to use a set of grids {S1, S2, S3} to construct a set of 3D surfaces {SF1, SF2, SF3}.

FIG. 9 shows the spline curve constructed from a point P on the screen and the set of 3D surfaces {SF1, SF2, SF3}.

FIG. 10 illustrates how to construct the Z-depth function evaluator EV.

FIG. 11 indicates two objects in space can be separated by their Z-depths.

FIG. 12 illustrates how to extract the outer edges (or profile lines) by using a set of parallel lines to intersect an extracted object.

### DETAILED DESCRIPTION OF THE PREFERRED EMBODIMENT

The present invention is described below in detail.

### (1) Constructing a Pair of Dual Cameras.

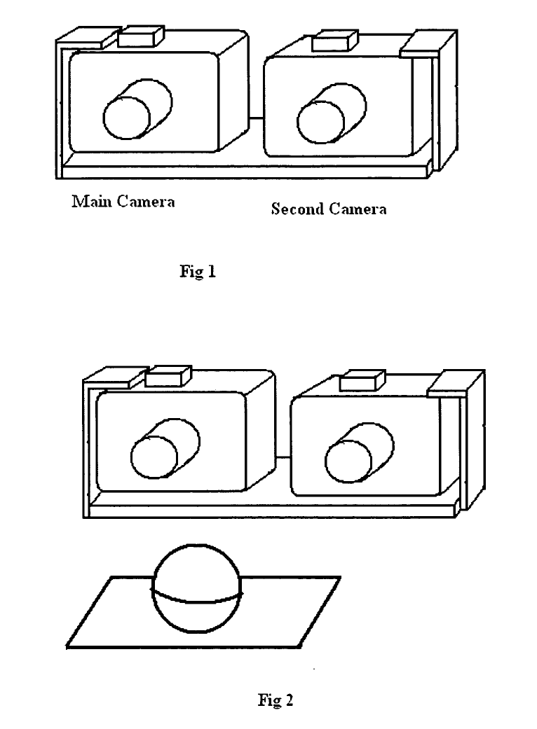

In FIG. 1, we show how to construct a pair of dual cameras. Two cameras are mounted onto a frame such as piece of board so they will remain in relatively fixed position all the time. The cameras are mounted for stereoscopic ability. The camera on the left is called the main camera and the camera on the right is called the second camera. Note that
(a) The camera mentioned here can be any electronic device that can make digital images. For convenience we call the video device as camera.
(b) The distance between the two cameras can be set at any desired length.
(c) The two cameras do not have to be parallel. The angles of the cameras can be set at any desired values.
(d) It is not important to assign the left or right camera as the main one. For convenience we assign the left one as the main camera.
   When the dual cameras are used to take a picture, both buttons of the cameras should be pressed simultaneously so that the shutters operate simultaneously to provide two pictures at the same time from two different angles. Also, when taking video, the video capture should be simultaneous to the best extent possible.

### (2) Viewing the Pictures Taken by the Dual Cameras.

For simplicity, in FIG. 2 we use the dual cameras to take the pictures of a sphere.

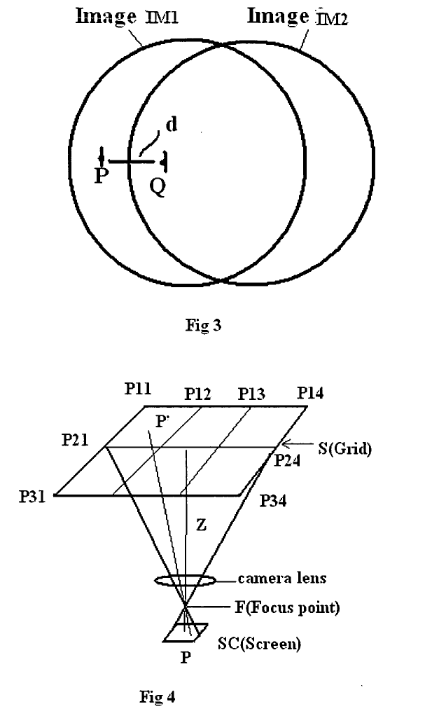

FIG. 3 shows the two simultaneous pictures IM1 and IM2 taken by the dual caners. FIG. 3 also shows Image IM2 is shifted to the right of IM1, since we have assumed the main camera is on the left. On the other hand, if we assume the right camera is the main one, then Image IM2 will shift to the left of IM1.

### (3) Identify a Pair (P, Q).

In FIG. 3, let P be a point on the sphere in Image IM1. Then there is always a corresponding point Q in Image IM2 such that (p, Q) are the same images of a point in space. Denote D as the distance between P and Q. Then the value of D is depending on the Z-depth of P.

Definition: Let P be a point on an image. Let P′ be the point in space such that P is the image of P′. Then The distance from P′ to the camera, is called the Z-depth of P.

### (4) For any Point P in IM1 Calculating the Z-Depth of P.

From (1), (2) and (3), we know that
(a) For any point P in Image IM1, we can always find a corresponding point Q in Image IM2.
(b) The distance D between (P, Q) depends on the Z-depth of P.

Question: Can we use the value D to find the unknown Z-depth of P?

Much research has been conducted in finding solutions to the above question. In general, this is a very difficult problem. The value of Z depends on many parameters such as the camera location, camera focal length, camera orientation, lance surface curvature and complicated math equations. So far, all the known methods can not get satisfactory answers.

In order to solve this problem, this invented device will take a different approach other than the classic algorithms. The new approach is that we will construct a processor such as a microprocessor that can evaluate a depth function F. F is defined as:

Z=F(P, D, f1,f2)

I.e. F is a function such that by substituting (1) the point P, (2) the separating distance D and (3) focal lengths f1 and f2 into F, we can obtain the Z-depth of P.

### (5) Constructing a Processor to Evaluate the Z-Depth Function

As we have said, the Z-depth function F does not have a closed form solution and it is very difficult to calculate, we will build a processor to evaluate F. We define:

A processor such as a microprocessor that can evaluate the Z-depth function F is called an evaluator EV of F.

Evaluator EV can be constructed in the following steps:

Step 1: Set the Dual Cameras.
(1) Set the main and second camera focal lengths to two fixed numbers f1 and f2.
(2) Position the dual cameras at a fixed location.
(3) Assume the main camera is on the left (see FIG. 1).
(4) Providing a processor such as a microprocessor

Step 2: Build a Grid in Space.

In FIG. 4, S is a 3×4 grid. The grid can be physical made of a structure such as wood, iron or any other suitable material to build this grid. S will play an important role in constructing the evaluator EV of the Z-depth function F.

Note that:
(1) The grid S that we construct here is a flat object. It lies on a plane S-PL.
(2) The plane S-PL which contain S is called the underneath surface of S.
(3) S does not have to be a 3×4 grid. It can be any m×n grid, where m and n are any positive finite integers.

Step 3: Use Grid S to Construct a Set of 3D Points.

In FIG. 4, we denote SC as the screen of the main camera. We move S around and put it in a certain place such that
(1) S is parallel to SC and
(2) The images IM1 and IM2 of S will occupy the entire screen of the main camera.
(3) Denote the distance between S and SC as Z (see FIG. 4)

Now let us use the dual cameras to take pictures of the grid S. We will then obtain two images IM1 and IM2.

In FIG. 4, we denote the vertices of S as:

| | | | | |
|---|---|---|---|---|
| (GP1) | P11 | P12 | p13 | P14 |
| | P21 | P1\22 | P23 | P24 |
| | P31 | P32 | P33 | P34 |

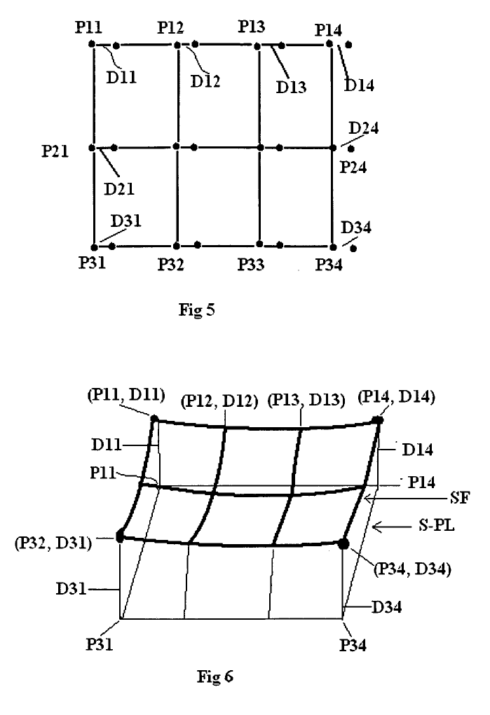

Image IM2 will shifts to the right of image IM1. In FIG. 5, we denote the shifting between IM1 and IM2 as

| | | | | |
|---|---|---|---|---|
| (Sep1) | D11 | D12 | D13 | D14 |
| | D21 | D22 | D23 | D24 |
| | D31 | D32 | D33 | D34 |

In FIG. 6, we use the above vertices {Pij|i from 1 to 3, j from 1 to 4} and differences {Dij|i from 1 to 3, j from ′ to 4} to construct a set of 3D points

(VERT3D)

| | | | |
|---|---|---|---|
| (P111, D11) | (P12, D12) | (p13, D13) | (P14, D14) |
| (P21, D21) | (P22, D22) | (p23. D23) | (P24, D24) |
| (P31, D31) | (P32, D32) | (P33, D33) | (P34, D34) |

Step 4: Use the Constricted 3D Points to Construct a 3D Surface.

Let S-PL be the said underneath plane of the grid S. In FIG. 6, a smooth 3D surface SF is constructed over S-PL such that SF contains all the constructed 3D points (VERT3D). There are many different ways to build a surface SF over G-PL which passes through all the vertices (VERT3D). For simplicity, we just say SF is a NURBS surface ([9]). Hence, SF can be represented as a function FN, i.e.

D=FN(P′),

where P′ is a point on the underneath plane S-PL. However, every point P′ on S-PL can be projected to screen SC through the focal point F of the camera (see FIG. 4). Hence surface SF can also be written as:

D=FN(P),

where P is a point of the screen SC.

Note that
(1) SF is constructed from (GP1) which is a set of 3×4 grid points on underneath plane S-PL. However, (GP1) does not have to be a set of grid points. In fact (GP1) can be any set of points on S-PL and we can still construct a smooth surface over (GP1).
(2) We have said that the underneath surface SP-L of S is a plane. However, S-PL does not have to be a plane. It can be any free form 3D surfaces ([9]).

Step 5: Construct a Set of Grids.

Now we construct a set of different sizes of grids {Si|I from 1 to k} in space. For simplicity, in FIG. 7, we only construct 3 grids {S1, S2, S3}. Repeating step 2 on each grid, we will then obtain a set of distances {Z1, Z2, Z3}, such that {S1, S2, S3} will be projected onto the entire screen SC (see FIG. 7). Note again for all {Si|I from 1 to k}
(a) The grid Si is not necessarily a plane. It can be a curved surface such as a sphere or any free form 3D surface.
(b) Points that lie on Si are not necessarily a set of m×n points. They can be any set of points on the grids.

Step 6: Construct a Set of 3D Surfaces.

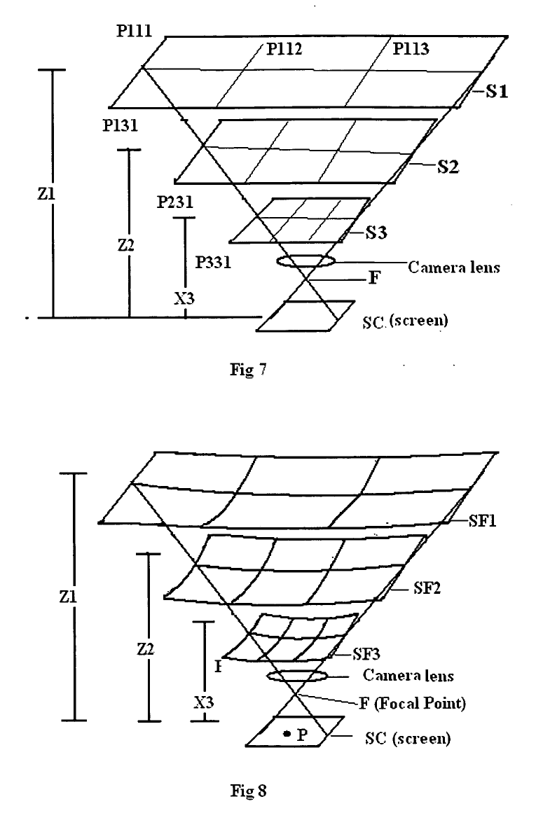

In FIG. 8, we apply the method of step 2 and 3 on each grid of {S1, S2, S3}. Then we obtain three NURBS surfaces SF1, SF2 and SF3. Similarly, we also get a set of functions {FN1(P), FN2}P), FN3(P)} such that:

D1=FN1(P)

D2=FN2(P)

D3=FN3(P) (FN)

Step 7: For any Point P on Screen SC, Construct a Spline Curve SP.

For any point P on the screen SC, we can substitute P in the said functions (FN) and obtain a set of numbers {D1, D2, D3}. In FIG. 9, {D1, D2, D3} and the said {Z1, Z2, Z3} obtained in step 5 were combine to form a set of 2D points.

(Z1, D1) (Z2, D2) (Z3, D3) (VERT2D)

In FIG. 9, a Spline curve SP ([9]) was constructed such that SP will pass through all the vertices of (VERT2D).

Step 8: Define the Evaluator EV of the Z-Depth Function.

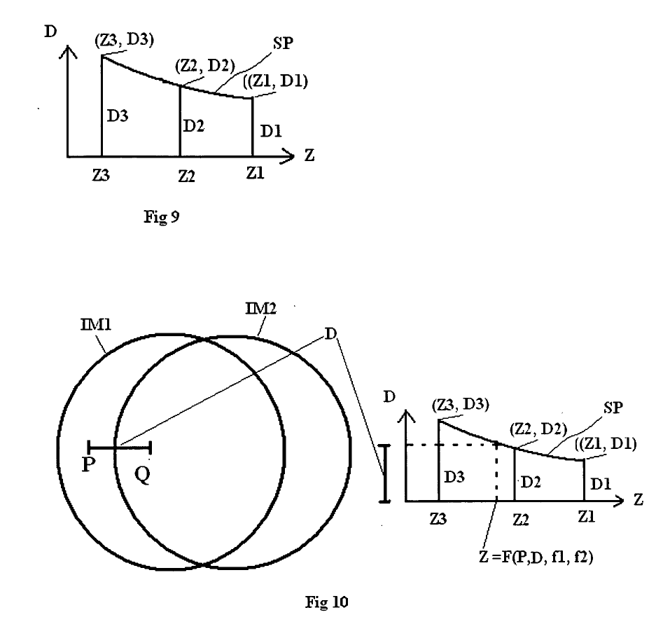

In FIG. 10, IM1 and IM2 are the two photos taken by the dual cameras. For any point P on IM1, the evaluator EV is defined as follows:
1. Use the surfaces {SF1, SF2, SF3} and P to construct the spline SP.
2. Find the point Q on IM2 such that (P, Q) are the images of the same point in space.
3. Measure the distance D between P and Q.
4. Use D to find a value Z on SP (see FIG. 10) such that D=SP(Z).
5. Define Z=EV(P)=the Z-depth of P.
6. Store {SF1, SF2, SF3} to database.
   Steps 1 to 6 have demonstrated that once we set the focal lengths of the main and second camera to two fixed numbers f1 and f2, we can obtain a set of said surfaces {SF1, SF2, SF3}. We shall collect f1, f2 and the constructed 3D surfaces into one object and denote it as:

OBJ(f1, f2)={f1, c2, SF1, SF2, SF3}

Now for a set of different pair of focal lengths {(g1, g2), (h1, h2) . . . (p1,p2)}, we will have a collection of different objects. We denote

OBJ={OBJ(f1, f2). OBJ(g1, g2). OBJ(h1, h2) . . . OBJ(p1,p2)}

To avoid repeated calculation, we can store OBJ in database. Whenever the dual cameras need to be set at different focal lengths, say (h1, h2), then we can just retrieve OBJ(h1, h2) from the database instead of trying to recalculate the set of 3D surfaces.

### (7) Extract Objects.

In FIG. 11, for simplicity we use S1 and S2 to represent two separated objects in space. Let P1 and P2 be two connected pixels of S1, Then the Z-depths Z1 and Z2 (of P1 and P2) are connected. If we denote:

S1-COMP={Z1, Z2 . . . Zm|for all the Z-depths of S1}

S2-COMP={Z′1, Z′2 . . . Z′n|for all the Z-depths of S2}

Yhen FIG. 11 also shows that
(a) S1-COMP and S2-COMP are two connected components and
(b) S1-COMP and S2-COMP are separated.

Hence, after all the Z-depths are calculated, if we separate the Z-depths into different connected components, then we can extract all the objects in the images.

### (8) Find the Outer Edges (or Profile Lines) of an Object.

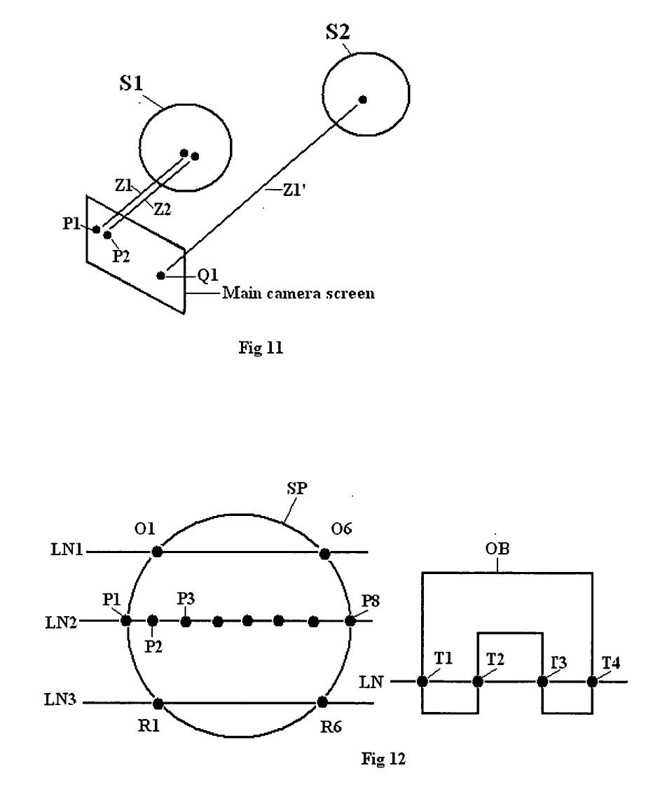

Once an object O is extracted from a photo, we can always find the outer edges (or profile lines) of O by using a set of parallel lines {L1N1, LN2 . . . LNk|k any integer} to intersect O. In FIG. 12, let SP be an extracted object. For simplicity, only 3 lines {LN1, LN2. LN3} are drawn. In FIG. 12, {P1, P2 . . . P8} are the intersecting points of LN2 and SP. Then we have:
(a) {P1, P8} are the boundary points of the intersection points, {P1, P2 . . . P8}.
(b) {P1, P8} are lying on the outer edges (or profile lines) of SP.
   Note that the boundary points of the intersection points are not always just the left most and right most points. On the right hand side of FIG. 12, it shows that {T1, T2, T3, T4} are the boundary points of line LN which intersects the object OB.
(c) FIG. 12, shows that the outer edges (or profile lines) is the collection of all the boundary points i.e. {Q1, P1, P3, R6, P8, Q6} of the outer edges (or profile lines) of S.

1. A method of constructing a Z-depth function evaluator, EV comprising the steps of:
a) using dual cameras to take simultaneous images;
b) using a Z-depth calculation method comprising the steps of:
i) constructing a set of grids; {|S1, S2 . . . Sk|k any integer}
ii) setting the focal lengths of the dual cameras to fixed numbers;
iii) taking images of the constructed grids with the dual cameras;
iv) using the images of the grids to construct a set of surfaces; {SF1. SF2 . . . SFk|k any integer}
v) using the constructed surfaces {SF1. SF2 . . . SFk|k any integer} to construct a Z-depth function evaluator EV; and
vi) using the EV to calculate the Z-depths of digital images.

2. The method of claim 1, wherein
(a) the set of grids {S1, S2 . . . Sk|k any integer} is not a plane, but rather a curved surface; and wherein;
(b) points that lie on the set of grids are not a set of m×n points.

3. The method of claim 1, further comprising the steps of:
(a) inputting images IM1 and IM2 taken from the dual cameras;
(b) using the set of surfaces to construct a spline SP for any point P on IM1;
(c) finding a corresponding point Q on IM2 such that (P, Q) are images of the same point in space;
(d) measuring the distance D between (P, Q).
(e) using D and SP to find the Z-depth of P.

4. The method of claim 3, further comprising the steps of:
a. inputting images IM1 and IM2 taken from the dual cameras;
b. using a Z-depth calculation method comprising the steps of:
i. constructing a set of grids; {|S1, S2 . . . Sk|k any integer}
ii. setting the focal lengths of the dual cameras to fixed numbers;
iii. taking images of the constructed grids with the dual cameras;
iv. using the images of the grids to construct a set of surfaces; {SF1. SF2 . . . SFk|k any integer}
v. using the constructed surfaces {SF1. SF2 . . . SFk|k any integer} to construct a Z-depth function evaluator EV; and
vi. using the EV to calculate the Z-depths of digital images; and
c. separating the calculated Z-depths into different connected components
d. assigning each connected component as an extracted object.

5. The method of claim 3, further comprising the steps of:
1. extracting objects {O1, O2 . . . Ok|k any integer} from images IM1 and IM2;
2. using a set of lines {LN1, LN2 . . . LNk|k any integer} to intersect each extracted object Ok;
3. finding the boundary points of LNk intersecting Ok, for each line LNk;
4. collecting all boundary points to form outer edges of Ok.

6. A method of calculating the z-depths of digital images comprising the steps of:
a) using dual cameras to take simultaneous images;
b) retrieving a pre-built collection of objects OBJ={OBJ(f1, f2), OBJ(g1, g2), OBJ(h1, h2) . . . OBJ(p1,p2)} in a database; and
c) using a Z-depth calculation method comprising the steps of:
i) retrieving an object OBJ(f1, f2) from the database for any given focal lengths (f1, f2) of the dual cameras;
ii) using the retrieved surfaces {SF1. F2 . . . SFk|k any integer} to construct the said Z-depth function evaluator EV; and
iii) using EV to calculate the Z-depths of digital images.

7. The method of claim 6, further comprising the steps of:
a) inputting images IM1 and IM2 taken from the dual cameras;
b) a method of constructing the said OBJ(f1, f2), comprising the steps of:
i) constructing a set of grids; {|S1, S2 . . . Sk|k any integer}
ii) setting the focal lengths of the dual cameras to fixed numbers (f1, f2);
iii) taking images of the constructed grids with the dual cameras;
iv) using the images of the grids to construct a set of surfaces; {SF1. SF2 . . . SFk|k any integer}
v) forming OBJ(f1, f2) by including f1, f2 and surfaces{SF1. SF2 . . . SFk|k any integer}
c) storing the constructed OBJ(f1,f2) to database.

8. The method of claim 6, further comprising the steps of:
i) retrieving the constructed surfaces {SF1. SF2 . . . SFk|k any integer} contained in an OBJ(f1, f2)
ii) constructing a Z-depth function evaluator EV; and
iii) using the EV to calculate the Z-depths of digital images; and
iv) separating the calculated Z-depths into different connected components
v) assigning each connected component as an extracted object.

9. The method of claim 6, further comprising the steps of:
a. extracting objects {O1, O2 . . . Ok|k any integer} from images IM1 and IM2;
b. using a set of lines {LN1, LN2 . . . LNk|k any integer} to intersect each extracted object Ok;
c. finding the boundary points of LNk intersecting Ok, for each line LNk;
d. collecting all boundary points to form outer edges of Ok.
